(19) United States
(12) Patent Application Publication
(10) Pub. No.: US 2009/0189516 A1
(43) Pub. Date: Jul. 30, 2009

(54) ORGANIC EL LIGHT EMITTING DISPLAY

(75) Inventors: Noboru Kurata, Matsumoto City (JP); Yukinori Kawamura, Matsumoto City (JP); Kouki Kasai, Matsumoto City (JP); Koji Kawaguchi, Matsumoto City (JP)

Correspondence Address: ROSSI, KIMMS & McDOWELL LLP., 20609 Gordon Park Square, Suite 150, Ashburn, VA, 20147, US

(73) Assignee: FUJI ELECTRIC HOLDINGS CO., LTD., Kawasaki (JP)

(21) Appl. No.: 12/066,521

(22) PCT Filed: Nov. 9, 2006
(86) PCT No.: PCT/JP2006/322386

§ 371 Date: Jun. 19, 2008

(30) Foreign Application Priority Data
Nov. 11, 2005 (JP) 2005-328022

(51) Int. Cl. H01J 1/63

(52) U.S. Cl. 313/504

(57) ABSTRACT

An organic EL light emitting display employs a color conversion system having a structure in which generation of dark areas in an organic EL element can be suppressed and emission of the organic EL light emitting element can be made highly efficient. The organic EL light emitting display successively includes a transparent substrate, one kind or a plurality of kinds of color filter layers, a bonding layer, a color conversion layer, a barrier layer, a transparent electrode, an organic EL layer and a reflecting electrode. The color filter layer is formed by a wet process, the color conversion layer and the barrier layer are formed by a dry process, and the bonding layer is selected from a group consisting of an inorganic bonding layer, an organic bonding layer, and a laminated body of an organic bonding layer and an inorganic bonding layer.

### TECHNICAL FIELD

The present invention relates to a high-definition high-visibility multicolor-displayable organic EL light emitting display. It particularly relates to an organic EL light emitting display in which a color conversion layer and a bonding layer and a barrier layer between which the color conversion layer is held are formed by dry process. The organic EL light emitting according to the invention is useful as a display device in a personal computer, a word processor, a television, a facsimile, an audio, a video, a car navigation, a desk-top calculator, a telephone, a portable terminal, an industrial instrument, etc.

### BACKGROUND ART

As systems for producing a full-color display using an organic EL light emitting element, there have been proposed a “three-color light emitting system” in which elements capable of emitting red light, blue light and green light respectively by application of electric field are arranged, a “color filter system” in which emission of white light is cut by color filters to express red, blue and green, and a “color conversion system” in which fluorescent pigments capable of absorbing near-ultraviolet light, blue light, bluish green light or white light and performing wavelength distribution conversion to emit light in a visible light range are used as filters.

Among them, it is thought that the color conversion system can achieve high color reproducibility and efficiency. It is further thought that the difficulty of increasing the screen size of a display using the color conversion system is low because a single-color organic EL light emitting element can be used differently from the three-color light emitting system. From these points, the color conversion system is treated favorably as a candidate for next-generation displays. An example of the structure of an organic EL light emitting display using the color conversion system is shown in FIG. 4. In the configuration of FIG. 4, there is formed a color conversion filter in which three kinds of color filter layers 32 (R, G and B), three kinds of color conversion layers 33 (R, G and B), a flattening layer 34 and a barrier layer 35 are formed on a transparent substrate 31. An organic EL element including a transparent electrode 41, an organic EL layer 42 and a reflecting electrode 43 is further formed on the color conversion filter to thereby configure an organic EL light emitting display.

Generally, the color conversion layer 33 used in the color conversion system has a structure in which one kind or a plurality of kinds of fluorescent pigments (inclusive of dye, pigment, and pigmentized particles having dye dispersed in a resin separately) are dispersed in a resin. The color conversion layer 33 has been heretofore formed by wet process in which the dispersion of the fluorescent pigment and resin is applied and dried. The color conversion layer 33 formed by such wet process, however, generally has a film thickness of from 5 μmm to 20 μmm, which is very thick compared with the other layers forming the organic EL light emitting display. Moreover, when a plurality of kinds of color conversion layers 33 are used, there is a possibility that a difference in level may be formed because the respective color conversion layers 33 are different in thickness. It may be necessary to provide a flattening layer 34 in order to compensate for the difference in level.

Moreover, it is difficult to completely dry the color conversion layer 33 formed by wet process. There is a possibility that non-emission defects also called dark areas may be generated because the water content remaining in the color conversion layer 33 moves to the organic EL layer 42 in a process of producing the organic EL light emitting display and/or in a period of driving the organic EL light emitting display.

With respect to the aforementioned problem, there has been discussed how to form the color filter layer and the color conversion layer by dry process (see Patent Documents 1 to 3).

Patent Document 1: JP-A-2001-196175

Patent Document 2: JP-A-2002-175879

Patent Document 3: JP-A-2002-184575

### DISCLOSURE OF THE INVENTION

### Problem that the Invention is to Solve

An object of the invention is to provide an organic EL light emitting display using a color conversion system having a novel structure in which generation of dark areas in an organic EL element can be suppressed and in which emission of light from the organic EL element can be used with high efficiency.

### Means for Solving the Problem

The organic EL light emitting display according to the invention successively includes a transparent substrate, one kind or a plurality of kinds of color filter layers, a bonding layer, a color conversion layer, a barrier layer, a transparent electrode, an organic EL layer, and a reflecting electrode, characterized in that: the color filter layer is formed by wet process; the color conversion layer and the barrier layer are formed by dry process; and the bonding layer is selected from a group consisting of an inorganic bonding layer, an organic bonding layer, and a laminated body of an organic bonding layer and an inorganic bonding layer. Preferably, the refractive index of the barrier layer is larger than the refractive index of the color conversion layer and smaller than the refractive index of the transparent electrode. Especially preferably, the refractive index of the barrier layer is larger than 1.9 and smaller than 2.2. The organic EL light emitting display according to the invention may further include a black matrix arranged in gaps of the one kind or the plurality of kinds of color filter layers. Preferably, the organic bonding layer has a refractive index not larger than 1.5. For example, the organic bonding layer can be formed of silicone resin. The color conversion layer may be formed selectively in a position corresponding to the one kind of color filter layer or at least one of the plurality of kinds of color filter layers.

The organic EL light emitting display according to the invention may further include a buffer layer between the color conversion layer and the barrier layer. The buffer layer may contain a film-forming resistant material. The buffer layer can be formed by a resistance heating evaporation method or an electron beam heating evaporation method.

### ADVANTAGE OF THE INVENTION

By employing the aforementioned configuration, a thin layer formed by dry process can be used as a color conversion layer in place of a thick layer formed by wet process. Moreover, sufficient adhesiveness of the color conversion layer can be obtained by the bonding layer. Moreover, the barrier layer can prevent dark areas from being caused by penetration of the water content into the organic EL layer though there is a possibility that the water content may remain in the color filter layer. Moreover, by matching the refractive indices of the color conversion layer, the barrier layer and the transparent electrode, emission of light from the organic EL element can be used with higher efficiency.

### BRIEF DESCRIPTION OF THE DRAWINGS

FIG. 1 is a sectional view showing an example of configuration of an organic EL light emitting display according to the invention.

FIG. 2 is a sectional view showing another example of configuration of an organic EL light emitting display according to the invention.

FIG. 3 is a sectional view showing another example of configuration of an organic EL light emitting display according to the invention.

FIG. 4 is a sectional view showing an example of an organic EL light emitting display according to the background art.

FIG. 5 is a sectional view showing another example of configuration of an organic EL light emitting display according to the invention.

FIG. 6 is a sectional view showing another example of configuration of an organic EL light emitting display according to the invention.

### DESCRIPTION OF REFERENCE NUMERALS

11, 31 transparent substrate
12, 32 (R, G, B) color filter layer
13 inorganic bonding layer
14 color conversion layer
15, 35 barrier layer
16 organic bonding layer
17 buffer layer
21, 41 transparent electrode
22, 42 organic EL layer
23, 43 reflecting electrode
33 (R, G, B) (conventional type) color conversion layer
34 flattening layer

### BEST MODE FOR CARRYING OUT THE INVENTION

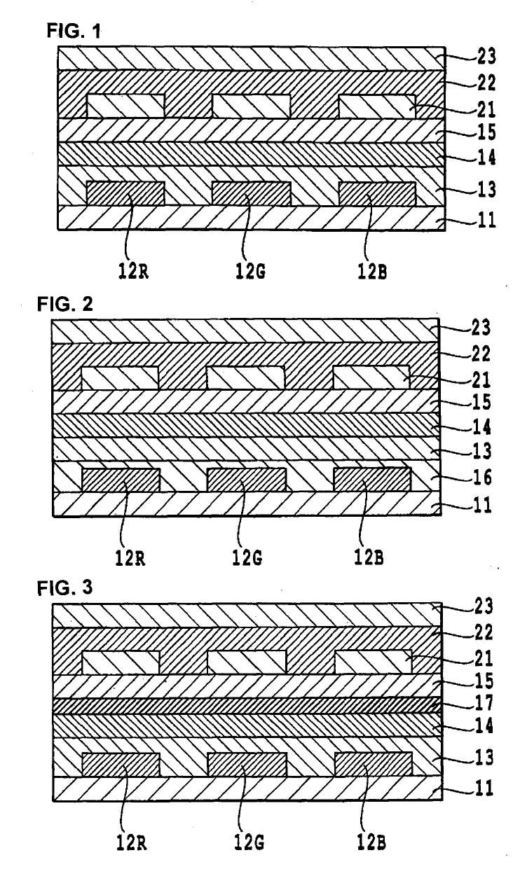

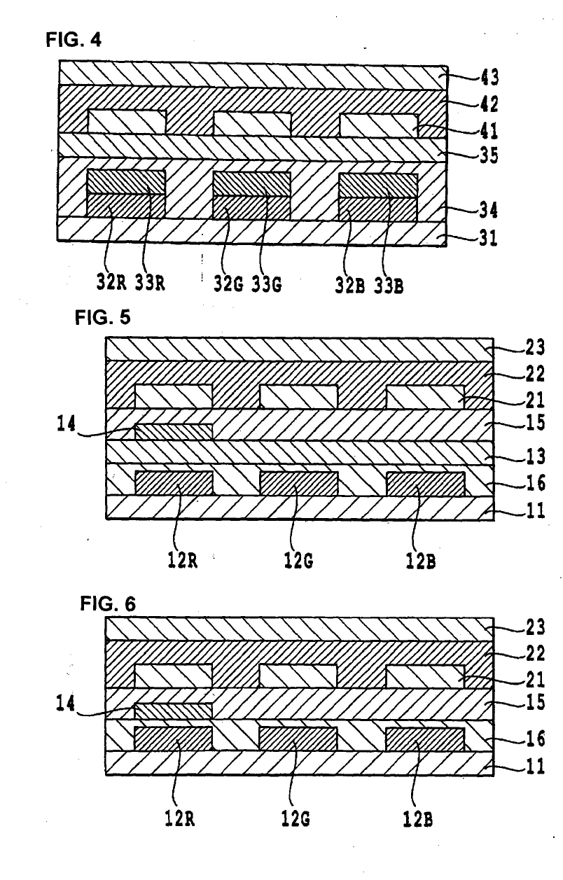

An example of configuration of an organic EL light emitting display according to the invention is shown in FIG. 1. FIG. 1 shows an organic EL light emitting display employing a color conversion system in which three kinds of color filter layers 12 (R, G and B), a bonding layer, a color conversion layer 14, a barrier layer 15 and an organic EL element are formed on a transparent substrate 11. The organic EL element includes a transparent electrode 21, an organic EL layer 22, and a reflecting electrode 23. The three kinds of color filter layers 12 (R, G and B) are formed by wet process whereas the color conversion layer 14 and the barrier layer 15 are formed by dry process.

The transparent substrate 11 is formed of a material which is excellent in visible light transmittance and which is prevented from causing lowering of performance of the organic EL light emitting display in a process of producing the organic EL light emitting display. Preferred examples of the transparent substrate 11 include a glass substrate, and a rigid resin substrate made of a resin. For example, polyolefin, acrylic resin (inclusive of polymethyl methacrylate), polyester resin (inclusive of polyethylene terephthalate), polycarbonate resin, polyimide resin or the like can be used as the resin. A flexible film made of polyolefin, acrylic resin (inclusive of polymethyl methacrylate), polyester resin (inclusive of polyethylene terephthalate), polycarbonate resin, polyimide resin or the like may be also used as the transparent substrate 11. Borosilicate glass, blue plate glass or the like is especially preferred as a material for forming the glass substrate used as the transparent substrate 11.

Each color filter layer 12 in the invention is a layer which performs spectral processing of incident light to transmit only light in a desired wavelength range. In the configuration shown in FIG. 1, a red color filter layer 12R, a green color filter layer 12G and a blue color filter layer 12B are used as the three kinds of color filter layers. One kind, two kinds or four or more kinds of color filter layers may be however used if necessary. Each color filter layer 12 can be formed of a material in which a dye or pigment having a desired absorption is dispersed in a high-molecular matrix resin. Examples of the material which can be used include any materials known in the art concerned, such as commercially available materials for flat panel display, e.g. color filter materials for liquid crystal (Color Mosaic made by FUJIFILM Electronic Materials Co., Ltd., etc.). Each color filter layer 12 in the invention has a film thickness of from 0.5 μmm to 5 μmm, preferably from 1 μmm to 3 μmm, to obtain light in the desired wavelength range with high color purity.

Each color filter layer 12 in the invention is formed by wet process which preferably includes application of liquid material (solution or dispersion), light patterning, and removal of unnecessary parts due to a developing solution to achieve required high definition. In order to improve stability of an organic EL light emitting display product, it is desirable that the transparent substrate 11 and the color filter layers 12 are heated at a high temperature to sufficiently remove the water content remaining in the color filter layers 12 after completion of the formation of the color filter layers 12 by wet process.

Though not shown in FIG. 1, a black matrix opaque to light may be formed in a gap between the respective color filter layers 12. Similarly to the color filter layers 12, the black matrix can be formed of any material known in the art concerned, such as a commercially available material for flat panel display, and can be produced by wet process. The black matrix is effective in improving the contrast ratio of the organic EL light emitting display. When the black matrix is provided, the black matrix may be formed before or after the color filter layers 12 are formed. Part of the black matrix and part of the color filter layers 12 may be made to overlap each other so that light from the organic EL element can surely pass through the color filter layers 12 and go out from the color filter layers 12. When the black matrix is formed, it is desirable that the high-temperature heating process to remove the water content is performed after all the color filter layers 12 and the black matrix are formed.

The bonding layer is then formed so as to cover the color filter layers 12 (and the black matrix if it is present). The bonding layer in the invention is a layer for improving adhesiveness of the color conversion layer formed on the bonding layer by dry process. The bonding layer in the invention may be an inorganic bonding layer 13 as shown in FIGS. 1 and 3 or an organic bonding layer 16 shown in FIG. 6 or a laminated body of the organic bonding layer 16 and the inorganic bonding layer as shown in FIGS. 2 and 5. When a laminated body of the organic bonding layer 16 and the inorganic bonding layer 13 is used, it is desirable that the inorganic bonding layer 13 is formed on the organic bonding layer 16.

In addition to the function of improving adhesiveness of the color conversion layer 14, the inorganic bonding layer 13 has a function of preventing penetration of the water content, oxygen and low-molecular content, etc. into the organic EL element from the cooler filter layers 12 formed under the inorganic bonding layer to thereby prevent lowering of the function of the organic EL layer 22. Moreover, it is desirable that the inorganic bonding layer 13 is transparent in order to transmit light from the color conversion layer 14 to the transparent substrate 11 side. To satisfy these requirements, the inorganic bonding layer 13 is formed of a material which is high in transparency in a visible light range (50% or more transmittance in a range of from 400 nm to 800 nm) and which has barrier characteristic to the water content and oxygen and low-molecular content. A silicon compound such as SiO₂, SiN, etc. or an aluminum compound such as Al₂O₃ can be used as a material for forming the inorganic bonding layer 13. The inorganic bonding layer 13 has a film thickness of from 100 nm to 2 μmm, preferably from 200 nm to 1 μmm. The inorganic bonding layer 13 can be formed by a sputtering method (inclusive of a high-frequency sputtering method, a magnetron sputtering method, etc.) which is dry process.

In addition to the function of improving adhesiveness of the color conversion layer 14, the organic bonding layer 16 has a function of compensating for a difference in level brought by the color filter layers 12. To give consideration to the point that light from the organic EL element passes through the organic bonding layer 16 and radiates to the outside, it is desirable that the material of the organic bonding layer 16 has excellent light transmission characteristic (preferably 50% or more transmittance, more preferably 85% or more transmittance to light in a wavelength range of from 400 nm to 800 nm). When the inorganic bonding layer 13 is formed on the top of the organic bonding layer 16 as shown in FIGS. 2 and 5, the organic bonding layer 16 is required to have sputter tolerance. The organic bonding layer 16 is generally formed by a coating method (spin coating, roll coating, knife coating, or the like). Examples of the material for forming the organic bonding layer 16 include thermoplastic resin (acrylic resin (inclusive of methacrylic resin), polyester resin (polyethylene terephthalate, etc.), methacrylate resin, polyamide resin, polyimide resin, polyether-imide resin, polyacetal resin, polyether-sulfone, polyvinyl alcohol and its derivatives (polyvinyl butyral, etc.), polyphenylene ether, norbornene resin, isobutylene-maleic anhydride copolymer resin, cyclic olefin resin), non-photosensitive thermosetting resin (alkyd resin, aromatic sulfonamide resin, urea resin, melamine resin, benzoguanamine resin), or photosetting resin. Each of these materials has a refractive index of 1.5 to 1.6.

Particularly when the color conversion layer 14 is selectively formed on a region of part of the bonding layer, it is desirable that the organic bonding layer 16 is formed of a material having a refractive index lower than the refractive index of the inorganic bonding layer 13. In this case, it is desirable that the organic bonding layer 16 has a refractive index of 1.5 or less. The use of a low refractive index material permits improvement of efficiency in extraction of light transmitted by other parts than the color conversion layer 14 among light emitted from the organic EL layer 22. Examples of such a low refractive index material include silicone resin having a refractive index of 1.4 to 1.5, and fluorinated polymer having a lower refractive index of about 1.4, which is obtained by (co)polymerization of fluorinated vinyl ether and/or perfluoro-olefin (hexafluroropropylene or the like).

When the organic bonding layer 16 is used, it is desirable that the laminated body of the transparent substrate 11, the color filter layers 12 and the organic bonding layer 16 (inclusive of the black matrix if it is present) is heated at a high temperature to sufficiently remove the water content remaining in the color filter layers 12 and the organic bonding layer 16 after the organic bonding layer 16 is formed. Or the color filter layers 12 (inclusive of the black matrix if it is present) may be heated at a high temperature to remove the water content remaining in the color filter layers 12 before the formation of the organic bonding layer 16 and the organic bonding layer 16 may be heated at a high temperature again to remove the water content remaining in the organic bonding layer 16 after the formation of the organic bonding layer 16. The removal of the water content remaining in these layers permits improvement of stability of an organic EL light emitting display product.

A region of the organic bonding layer 16 which does not overlap the color filter layers 12 has a film thickness of from 0.5 μmm to 3 μmm, preferably from 1 μmm to 2 μmm. The film thickness in such a range can compensate for the difference in level brought by the plurality of kinds of color filter layers 12 to thereby provide a flat upper plane.

The color conversion layer 14 is a layer which performs wavelength distribution conversion by absorbing part of incident light (light emitted from the organic EL element) to thereby release light having a different wavelength distribution, inclusive of non-absorbed part of the incident light and converted light. The color conversion layer 14 is a layer including at least one kind or a plurality of kinds of color conversion pigments. Preferably, the color conversion layer 14 converts blue light or bluish green light emitted from the organic EL element into white light. The “white light” in the invention includes not only light having wavelength components in a visible light range (400 nm to 700 nm) homogeneously but also light having the wavelength components heterogeneously but looking white with the naked eye. The color conversion pigment is a pigment which absorbs incident light and radiates light in a different wavelength range. Preferably, the color conversion pigment is a pigment which absorbs blue light or bluish green light emitted from a light source and radiates light in a desired wavelength range (e.g. green or red). Any pigment known in the art concerned can be used as the color conversion pigment. Examples of the pigment include: pigments for red light emitting material, such as DCM-1(I), DCM-2(II), DCJTB(III), 4,4-difluoro-1,3,5,7-tetraphenyl-4-bora-3a,4a-diaza-s-indacene(IV), Nile red (V), etc.; rhodamine pigment for radiating red light, cyanine pigment, pyridine pigment, oxazine pigment, etc.; coumarin pigment for radiating green light, naphthalimide pigment, etc.

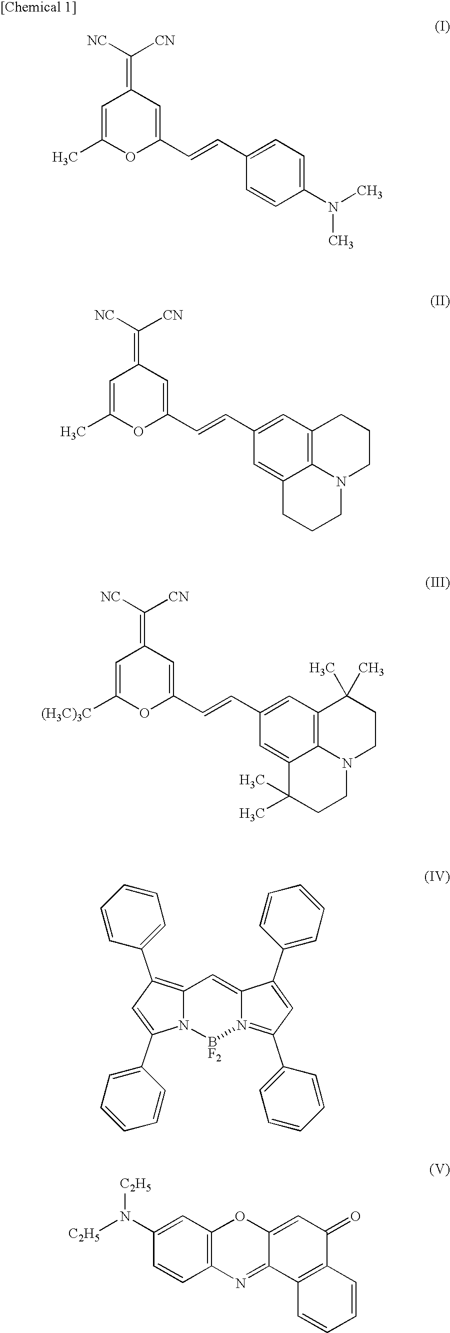

It is desirable that at least one kind of the color conversion pigments used in the invention is a pigment which can absorb light emitted from the EL element and release red light with a wavelength of 580 nm or higher. Or the color conversion layer 14 may include an additional material for improving characteristic of the color conversion layer 14 such as binding characteristic of the color conversion pigments. Examples of the additional material which can be used include an aluminum complex such as tris(8-quinolinolato)aluminum (Alq₃) or tris(4-methyl-8-quinolinolato)aluminum (Almq₃), 4,4′-bis(2,2-diphenylvinyl)biphenyl (DPVBi), 2,5-bis-(5-tert-butyl-2-benzooxazolyl)thiophene, etc.

The color conversion layer 14 is formed by dry process. The color conversion layer 14 may be formed on all the upper surface of the bonding layer or may be formed on a part region of the bonding layer selectively. For example, the color conversion layer 14 may be formed selectively on a position corresponding to one kind of color filter layer 12 or at least one kind in a plurality of kinds of color filter layers 12. For example, as shown in FIG. 5, the color conversion layer 14 can be formed only in a position corresponding to the red color filter layer 12R.

When the color conversion layer 14 is formed on all the upper surface of the bonding layer, the color conversion layer 14 can be formed by an evaporation method. When the color conversion layer 14 further including the additional material for improving characteristic is formed, the color conversion layer 14 can be formed by coevaporation of the color conversion pigment and the additional material.

When the color conversion layer 14 is formed selectively on a part region of the bonding layer, any one of the following methods can be used:
(1) An evaporation (coevaporation) method using a metal mask having an opening portion in a region to be formed;
(2) A method for forming a color conversion layer on all the upper surface of the bonding layer by using an evaporation (coevaporation) method and then removing the color conversion layer except the necessary region by using laser radiation or atmospheric plasma radiation; or
(3) A method for producing a transfer medium having a color conversion material layer formed by an evaporation (coevaporation) method on another support and then transferring the color conversion material layer by operating a heat or energy beam (such as light) in a necessary region.

The color conversion layer 14 has a film thickness in a range of from 100 nm to 1 μmm, preferably from 150 nm to 600 nm. Accordingly, the color conversion layer 14 in the invention is different from the conventional type color conversion layer formed by application and drying of a color conversion pigment/matrix resin composition, that is, a difference in level to cause a failure such as wire-breaking or short-circuiting of the transparent electrode 21 and the reflecting electrode 23 is not formed in the color conversion layer 14 in the invention. Accordingly, the necessity of providing a flattening layer on the color conversion layer 14 can be removed.

The conventional type color conversion layer formed by application and drying of the color conversion pigment/matrix resin composition has a possibility that the water content to cause degradation of the organic EL element may be contained in the conventional type color conversion layer. The color conversion layer in the invention is however free from the water content to cause degradation of the organic EL element because the color conversion layer in the invention is formed by dry process.

The barrier layer 15 is a layer which has a function of preventing penetration of the water content from the color filter layers 12 into the organic EL layer side, and a function of protecting the color conversion layer 14 from the process of forming the transparent electrode 21 of the organic EL element formed on the barrier layer 15. Accordingly, the barrier layer 15 is formed of a material having barrier characteristic to the water content, oxygen and low-molecular content. It is further desirable that the barrier layer 15 is transparent in the wavelength range of light emitted from the organic EL layer 22 to efficiently transmit the light to the color conversion layer 14 side and satisfies the relation of (refractive index of the color conversion layer 14)<(refractive index of the barrier layer 15)<(refractive index of the transparent electrode 21). With respect to transparency, it is desirable that the barrier layer 15 has a high transmittance of 50% or more in a range of from 400 nm to 800 nm. Giving consideration to typical materials of the color conversion layer 14 and the transparent electrode 21, it is desirable that the material of the barrier layer 15 satisfies the relation of 1.9<(refractive index of the barrier layer 15)<2.2. A preferred material of the barrier layer 15 contains SiN, SiNH, AlN, etc.

The barrier layer 15 has a film thickness in a range of from 100 nm to 2 μmm, preferably from 200 nm to 1 μmm, and is formed so as to cover the color conversion layer 14 under the barrier layer 15 and layers below the color conversion layer 14.

The barrier layer 15 can be formed by a sputtering method or a CVD method which is dry process. The sputtering method may be a high-frequency sputtering method or a magnetron sputtering method. It is desirable that the CVD method is a plasma CVD method. An arbitrary means known in the art concerned, such as high-frequency electric power (which may use a capacitive coupling type or an inductive coupling type), ECR, helicon wave, etc., may be used as the plasma generating means in this process. In addition to electric power with an industrial frequency MHz), electric power with a frequency in a UHF or VHF range can be used as the high-frequency electric power.

When the CVD method is used for forming the barrier layer 15, an Si source which can be used in the invention includes SiH₄, SiH₂Cl₂, SiCl₄, Si(OC₂H₅)₄, etc. An Al source which can be used in the invention includes AlCl₃, Al(O-i-C₃H₇)₃, an organic aluminum compound (trimethylaluminum, triethylaluminum, tributylaluminum, or the like), etc. It is convenient that NH₃ is used as an N source in the invention. In addition to these raw material gasses, H₂, N₂ or inert gas (He, Ar, etc.) may be introduced as diluting gases into a CVD apparatus.

A buffer layer 17 may be formed on the color conversion layer 14 before the barrier layer 15 is formed by a sputtering method or a CVD method as described above (see FIG. 3). The buffer layer 17 is effective in protecting the color conversion pigments in the color conversion layer 14 from plasma, high energy particles (neutral atom or ionized atom), high-speed electrons or ultraviolet rays which are generated in the process for forming the barrier layer 15 (sputtering method or CVD method). The provision of the buffer layer 17 between the color conversion layer 14 and the barrier layer 15 permits prevention of decomposition of the color conversion pigments caused by various factors as described above and prevention of loss of the color conversion function caused by the decomposition of the color conversion pigments.

The buffer layer 17 can be formed of a film-forming resistant material (i.e. a material having either or both of sputter resistance and plasma resistance). For example, such a material includes a metal complex, especially a metal chelate complex. Examples of the metal chelate complex which can be used include metal phthalocyanine such as cupper phthalocyanine (CuPc), etc., or aluminum chelate complex such as tris(8-hydroxyquinolinato)aluminum (Alq₃) or tris(4-methyl-8-hydroxyquinolinato)aluminum (Almq₃). Or inorganic fluoride, especially alkaline-earth metal fluoride (MgF₂, CaF₂, SrF₂, BaF₂, etc.) can be used for forming the buffer layer 17.

A method using low-energy film-forming particles, such as a resistance heating evaporation method or an electron beam heating evaporation method, can be used for depositing the aforementioned film-forming resistant material to thereby form the buffer layer 17. It is desirable that the buffer layer 17 has a film thickness of from 50 nm to 100 nm. The provision of such a film thickness permits the buffer layer 17 as a uniform film to protect the color conversion layer 14 effectively.

The organic EL light emitting element which can be used in the invention has a structure in which the transparent electrode 21, the organic EL layer 22 and the reflecting electrode 23 are laminated successively in this order. The organic EL layer 22 at least includes an organic light emitting layer and has a structure in which a hole injection layer, a hole transport layer, an electron transport layer and/or an electron injection layer are interposed if necessary. Or a hole injection transport layer having both functions of injection and transport of holes or an electron injection transport layer having both functions of injection and transport of electrons may be used. Specifically, the organic EL element employs layer structures as follows.
(1) positive electrode/organic light emitting layer/negative electrode
(2) positive electrode/hole injection layer/organic light emitting layer/negative electrode
(3) positive electrode/organic light emitting layer/electron injection layer/negative electrode
(4) positive electrode/hole injection layer/organic light emitting layer/electron injection layer/negative electrode
(5) positive electrode/hole transport layer/organic light emitting layer/electron injection layer/negative electrode
(6) positive electrode/hole injection layer/hole transport layer/organic light emitting layer/electron injection layer/negative electrode
(7) positive electrode/hole injection layer/hole transport layer/organic light emitting layer/electron transport layer/electron injection layer/negative electrode

In the aforementioned layer structures, the positive electrode and the negative electrode correspond to one of the transparent electrode 21 and the reflecting electrode 23 and the other thereof, respectively. Because it is known in the art concerned that it is easy to make the positive electrode transparent, it is desirable also in the invention that the transparent electrode 21 is used as the positive electrode and the reflecting electrode 23 as the negative electrode. It is desirable that the transparent electrode 21 is transparent in the wavelength range of light emitted from the organic EL layer 22.

The respective layers which form the organic EL layer 22 can be formed by using known materials in the art concerned. For example, to obtain emission of blue light or bluish green light, a fluorescent brightening agent such as benzothiazole, benzoimidazole, benzooxazole, etc., a metal chelating oxonium compound, a styrylbenzene compound, an aromatic dimethylidene compound, etc. can be preferably used as the organic light emitting layer. Preferably, the respective layers which form the organic EL layer 22 are formed by an evaporation method.

It is desirable that the transparent electrode 21 has a transmittance of preferably 50% or higher, more preferably 85% or higher, to light with a wavelength of from 400 nm to 800 nm. The transparent electrode 21 can be formed of ITO (In—Sn oxide), Sn oxide, In oxide, IZO (In—Zn oxide), Zn oxide, Zn—Al oxide, Zn—Ga oxide or electrically conductive transparent metal oxide containing a dopant such as F, Sb, etc. added to these oxides. The transparent electrode 21 is formed by an evaporation method, a sputtering method or a chemical vapor deposition (CVD) method. Preferably, the transparent electrode 21 is formed by a sputtering method. When the transparent electrode 21 having a plurality of partial electrodes is required as will be described later, electrically conductive transparent metal oxide may be formed uniformly all over the surface and then etched to give a predetermined pattern to thereby form the reflecting electrode 21 having the plurality of partial electrodes. Or a mask to give a predetermined shape may be used for forming the reflecting electrode 21 having the plurality of partial electrodes.

When the transparent electrode 21 is used as the negative electrode, it is desirable that a negative electrode buffer layer is provided in an interface between the transparent electrode 21 and the organic EL layer 22 in order to improve electron injection efficiency. Materials for forming the negative electrode buffer layer include alkali metals such as Li, Na, K, Cs, etc., alkaline-earth metals such as Ba, Sr, etc., alloys containing these metals, rare-earth metals or fluorides of these metals but are not limited thereto. The film thickness of the negative electrode buffer layer can be selected suitably under consideration of driving voltage, transparency, etc. In the ordinary case, it is desirable that the negative electrode buffer layer has a film thickness of 10 nm or less.

The reflecting electrode 23 is preferably formed of a high reflectance metal, a high reflectance amorphous alloy or a high reflectance microcrystalline alloy. The high reflectance metal includes Al, Ag, Mo, W, Ni, Cr, etc. The high reflectance amorphous alloy includes NiP, NiB, CrP, CrB, etc. The high reflectance microcrystalline alloy includes NiAl, etc. The reflecting electrode 23 may be used as the negative electrode or may be used as the positive electrode. When the reflecting electrode 23 is used as the negative electrode, the aforementioned negative electrode buffer layer may be provided in an interface between the reflecting electrode 23 and the organic EL layer 22 in order to improve efficiency in injection of electrons into the organic EL layer 22. Or when the reflecting electrode 23 is used as the negative electrode, an alkali metal such as lithium, sodium, potassium, etc. or an alkaline-earth metal such as calcium, magnesium, strontium, etc. which is a material small in work function can be added to the aforementioned high reflectance metal, amorphous alloy or microcrystalline alloy to thereby perform alloying in order to improve efficiency in injection of electrons. When the reflecting electrode 23 is used as the positive electrode, a layer of the aforementioned electrically conductive transparent metal oxide may be provided in an interface between the reflecting electrode 23 and the organic EL layer 22 in order to improve efficiency in injection of holes into the organic EL layer 22.

The reflecting electrode 23 can be formed by an arbitrary means known in the art concerned, such as evaporation (resistance heating or electron beam heating), sputtering, ion plating, laser ablation or the like, dependently on the materials used. When the reflecting electrode 23 having a plurality of partial electrodes is required as will be described later, a mask to give a predetermined shape may be used for forming the reflecting electrode 23 having the plurality of partial electrodes. Or partition walls (not shown) having a sectional shape like a reverse taper may be formed before lamination of the organic EL layer 22, so that the partition walls can be used for forming the reflecting electrode 23 having the plurality of partial electrodes.

In FIG. 1, in order to form a plurality of independent light emitting portions in the organic EL element, each of the transparent electrode 21 and the reflecting electrode 23 is formed from a plurality of stripe portions parallel with one another so that stripes forming the transparent electrode 21 and stripes forming the reflecting electrode 23 cross each other (preferably at right angles). Accordingly, the organic EL light emitting element can perform matrix driving. That is, when a voltage is applied between a specific stripe of the transparent electrode 21 and a specific stripe of the reflecting electrode 23, the organic EL layer 22 emits light in a portion where these stripes cross each other. Or one electrode (e.g. the transparent electrode 21) may be provided as a uniform flat electrode having no stripe pattern whereas the other electrode (e.g. the reflecting electrode 23) may be patterned as a plurality of partial electrodes corresponding to the respective light emitting portions. In this case, a plurality of switching elements corresponding to the respective light emitting portions may be provided and connected to the partial electrodes corresponding to the respective light emitting portions in the manner of one-to-one correspondence so that the so-called active matrix driving can be performed.

### EXAMPLES

### Example 1

A 0.7 mm-thick glass substrate 11 was cleaned ultrasonically in pure water, dried and cleaned with UV ozone. The cleaned glass substrate was coated with Color Mosaic CK-7800 (made by FUJIFILM Electronic Materials Co., Ltd.) by a spin coating method. Patterning was then performed by a photolithograph method to thereby form a 1 μm-thick black matrix in which a plurality of opening portions having a size of 0.09 mm wide×0.3 mm long were arranged at intervals of a widthwise pitch of 0.11 mm and a lengthwise pitch of 0.33 mm.

Red, green and blue color filter layers were then formed by use of Color Mosaic CR-7001, CG-7001 and CB-7001, respectively. After each color filter layer was applied, the color filter layer was patterned into a plurality of stripe portions by a photolithograph method. The stripe portions in each of the red color filter layer 12R, the green color filter layer 12G and the blue color filter layer 12B had a size of 0.10 mm wide and 1 μmm thick (on the glass substrate 11) and were arranged at intervals of a widthwise pitch of 0.33 mm. In this structure, each of the plurality of stripe portions in the black matrix overlapped any one of the color filter layers 12 respectively in a region of 0.005 mm from a side of the strip portion.

Then, NN810L (made by JSR Corporation) was applied by a spin coating method and then exposed to light, so that an organic bonding layer 16 to cover the color filter layers 12 and the black matrix was formed. The film thickness of the organic bonding layer 16 was 1.5 μmm in a region where the organic bonding layer 16 came in contact with the black matrix.

The thus obtained substrate having the organic bonding layer 16 and layers below the organic bonding layer 16 was heated at 200° C. for 20 minutes under a dry nitrogen atmosphere (water concentration of 1 ppm or less) to remove the water content having a possibility of remaining.

Then, a 300 nm-thick SiO₂ film was laminated by an AC sputtering method to obtain an inorganic bonding layer 13. A boron-doped type Si target was used as the target. While an Ar/O₂ mixture gas with a pressure of 1 Pa was used as a sputtering gas, an Ar flow rate and an O₂ flow rate were set to 200 SCCM and 80 SCCM respectively. Electric power of 3.5 kW was applied between the target and the counter electrode.

Then, the substrate having the inorganic bonding layer 13 formed thus was put in a vacuum evaporation apparatus and DCM-1 was evaporated on the substrate at an evaporation speed of 0.3 Å/s under a pressure of 1×10⁻⁴ Pa to form a color conversion layer 14 having a film thickness of 500 nm. It was proved from measurement of the refractive index of a DCM-1 film separately formed on a glass substrate in the same condition that the color conversion layer 14 in this example had a refractive index of 1.9.

A 300 nm-thick SiNH film was then laminated by a plasma CVD method to obtain a barrier layer 15. While SiH₄ of 100 SCCM, NH₃ of 500 SCCM and N₂ of 2000 SCCM were used as raw material gasses, the gas pressure was set to 80 Pa. RF electric power of 0.5 kW with 27 MHz was applied as plasma generating electric power. It was proved from measurement of the refractive index of an SiNH film separately formed on a glass substrate in the same condition that the barrier layer 15 in this example had a refractive index of 1.95.

An organic EL element was formed on the barrier layer 15 formed as described above. First, a 200 nm-thick IZO film was formed by a DC sputtering method. In-Zn oxide was used as a target and O₂ and Ar were used as sputtering gasses. Then, patterning was performed by a photolithograph method using an aqueous solution of oxalic acid as an etching solution to obtain a transparent electrode 21. The transparent electrode 21 was formed from a plurality of stripe portions (with a width of 0.1 mm and a pitch of 0.11 mm) which were located above the color filter layers 12 and extended in the same direction as that of stripes of the color filter layers 12. It was proved from measurement of the refractive index of an IZO film separately formed on a glass substrate in the same condition that the transparent electrode 21 in this example had a refractive index of 2.2.

Then, a polyimide film was formed by using Photoneece (made by TORAY Industries, Inc.) and an electrically insulating film was formed by a photolithograph method so that a plurality of opening portions (which served as light emitting portions of the organic EL element) having a size of 0.09 mm wide×0.3 mm long were arranged in the electrically insulating film at intervals of a widthwise pitch of 0.11 mm and a lengthwise pitch of 0.33 mm. On this occasion, the opening portions of the electrically insulating film were set so as to be located correspondingly to the opening portions of the black matrix. Then, reflecting electrode partition walls were formed. A negative type photoresist (ZPN1168 (made by ZEON Corporation) was applied by a spin coating method, prebaking was performed, a pattern of stripes extended in a direction perpendicular to the stripes of the transparent electrode 21 was baked by using a photomask, post-exposure baking was performed on a hot plate at 110° C. for 60 seconds, development was performed, and heating was finally performed on the hot plate at 180° C. for 15 minutes. Thus, the reflecting electrode partition walls were formed. The reflecting electrode partition walls obtained thus had a sectional shape of a reverse taper and were formed from a plurality of stripe portions extending in a direction perpendicular to that of the stripes of the transparent electrode 21.

The substrate having the reflecting electrode partition walls formed as described above was put in a resistance heating evaporation apparatus. A hole injection layer, a hole transport layer, an organic light emitting layer and an electron injection layer were successively formed with a vacuum kept. When film forming was performed, the inner pressure of a vacuum tank was reduced 1×10⁻⁴, Pa. A 100 nm-thick copper phthalocyanine (CuPc) film as a hole injection layer, a 20 nm-thick 4,4′-bis[N-(1-naphthyl)-N-phenylamino]biphenyl (α-NPD) film as a hole transport layer, a 30 nm-thick DPVBi film as a light emitting layer and a 20 nm-thick Alq₃ film as an electron injection layer were laminated to obtain an organic EL layer 22.

Then, a 200 nm-thick Mg/Ag (10:1 mass ratio) film was deposited with a vacuum kept. Thus, a reflecting electrode 23 formed from a plurality of partial electrodes shaped like stripes having a width of 0.30 mm and a pitch of 0.33 mm was obtained.

The device obtained thus was sealed with sealing glass and a UV-curable adhesive agent under a dry nitrogen atmosphere (water concentration of 1 ppm or less) in a globe box to obtain an organic EL light emitting display. The display obtained thus emitted white light with a luminance of 1000 cd/m² when a current with a current density of 62 mA/m² was applied initially. Although the obtained display was continuously driven at 85° C. for 1000 hours in the condition that white light (initial chromaticity (CIE), x=0.31, y=0.33) was emitted with a luminance of 1000 cd/m², generation of dark areas was not observed.

### Example 2

An organic EL light emitting display was obtained by repetition of the same procedure as in Example 1 except that the organic bonding layer 16 was not formed. Although the obtained display was continuously driven at 85° C. for 1000 hours in the condition that white light (initial chromaticity (CIE), x=0.31, y=0.33) was emitted with a luminance of 1000 cd/m², generation of dark areas was not observed.

### Example 3

An organic EL light emitting display was obtained by repetition of the same procedure as in Example 1 except that a 300 nm-thick SiO₂ film was used as the barrier layer 15. It was proved from measurement of the refractive index of an SiO₂ film separately deposited on a glass substrate in the same condition that the barrier layer 15 in this example had a refractive index of 1.5. The display obtained thus emitted white light with a luminance of 1000 cd/m² when a current with a current density of 80 mA/cm² was applied initially. It was found that efficiency was slightly lowered compared with the display in Example 1 because the refractive index of the barrier layer 15 did not match those of the transparent electrode 21 and the color conversion layer 14. On the other hand, although the obtained display was continuously driven at 85° C. for 1000 hours in the condition that white light (initial chromaticity (CIE), x=0.31, y=0.33) was emitted with a luminance of 1000 cd/m², generation of dark areas was not observed. It was found that the predetermined purpose was satisfied.

### Example 4

Layers from a black matrix to a color conversion layer 14 were formed on a glass substrate 11 by repetition of the same procedure as in Example 1. Then, Alq₃ was evaporated in a vacuum evaporation apparatus under a pressure of 1×10⁻⁴ Pa to thereby form a buffer layer 17 having a film thickness of 80 nm.

Then, a 300 nm-thick SiNH film was laminated by a plasma CVD method to thereby obtain a barrier layer 15. While SiH₄ of 100 SCCM, NH₃ of 500 SCCM and N₂ of 2000 SCCM were used as raw material gasses, the gas pressure was set to 80 Pa. RF electric power of 1.0 kW with 27 MHz was applied as plasma generating electric power. It was proved from measurement of the refractive index of an SiNH film separately formed on a glass substrate in the same condition that the barrier layer 15 in this example had a refractive index of 2.0 which was higher than the refractive index of the barrier layer in Example 1.

Then, an organic EL element was formed in the same procedure as in Example 1 to obtain an organic EL display. The obtained display emitted white light (initial chromaticity (CIE), x=0.31, y=0.33). Although the obtained display was further continuously driven at 85° C. for 1000 hours in the condition that white light was emitted with a luminance of 1000 cd/m², generation of dark areas was not observed. It was found from this fact that the provision of the buffer layer 17 could prevent the color conversion pigments in the color conversion layer 14 from being damaged even when RF electric power applied at the time of forming the barrier layer 15 was increased to increase the film-forming speed.

### Example 5

An organic EL light emitting display was obtained by repetition of the same procedure as in Example 1 except that the formation of the color conversion layer 14 was performed as follows. A metal mask in which a plurality of opening portions having a size of 0.09 mm wide×0.3 mm long were arranged at intervals of a widthwise pitch of 0.33 mm and a lengthwise pitch of 0.33 mm was prepared. The metal mask was aligned so that the opening portions were arranged in a position corresponding to the red color filter layer 12R. Then, DCM-1 was evaporated under a pressure of 1×10⁻⁴ Pa to thereby form a color conversion layer 14 having a film thickness of 500 nm. The obtained color conversion layer 14 was arranged only above the red light emitting portion as shown in FIG. 5 but was not arranged above the blue light emitting portion and the green light emitting portion.

Although continuous driving was performed in the same condition as in Example 1, generation of dark areas was not observed. When only the blue light emitting portion was made to emit light, and when only the green light emitting portion was made to emit light, the organic EL light emitting display in this example exhibited a 30-40% higher luminance compared with the display in Example 1. The increase of luminance was because the color conversion layer 14 was not arranged above the blue light emitting portion and the green light emitting portion.

### Example 6

An organic EL light emitting display having a configuration shown in FIG. 6 was obtained by repetition of the same procedure as in Example 5 except that the inorganic bonding layer 13 was not formed and the formation of the organic bonding layer 16 was performed as follows.

A glass substrate 11 on which color filter layers 12 and a black matrix were formed was coated with NN810L (made by JSR Corporation) by a spin coating method. The obtained film was then exposed to light to thereby form an organic bonding layer 16 to cover the color filter layers 12 and the black matrix. The film thickness of the organic bonding layer 16 was 1.5 μmm in a region where the organic bonding layer 16 came into contact with the black matrix. Then, the obtained substrate having the organic bonding layer 16 and layers below the organic bonding layer 16 was heated at 230° C. for 20 minutes under a dry nitrogen atmosphere (water concentration of 1 ppm or less) to remove the water content having a possibility of remaining. It was proved from measurement of the refractive index of an organic bonding layer separately formed on a glass substrate in the same condition that the organic bonding layer 16 in this example had a refractive index of 1.54. When the color conversion layer 14 was evaporated on the organic bonding layer 16, separation of the color conversion layer 14 was not observed.

Although continuous driving was performed in the same condition as in Example 1, generation of dark areas was not observed in the organic EL light emitting display in this example. When only the blue light emitting portion was made to emit light, and when only the green light emitting portion was made to emit light, the organic EL light emitting display in this example exhibited a 30-40% higher luminance compared with the display in Example 1. The increase of luminance was because the color conversion layer 14 was not arranged above the blue light emitting portion and the green light emitting portion.

### Example 7

An organic EL light emitting display was obtained by repetition of the same procedure as in Example 6 except that the organic bonding layer 16 was formed by using silicone resin (KP-85 made by Shin-Etsu Chemical Co., Ltd.) in place of NN810L (made by JSR Corporation). It was proved from measurement of the refractive index of an organic bonding layer separately formed on a glass substrate in the same condition that the organic bonding layer 16 in this example had a refractive index of 1.43. When the color conversion layer 14 was evaporated on the organic bonding layer 16, separation of the color conversion layer 14 was not observed.

Although continuous driving was performed in the same condition as in Example 1, generation of dark areas was not observed. With respect to all light emitting colors (red, green and blue), the organic EL light emitting display in this example exhibited a 30% higher luminance compared with the display in Example 6. The increase of luminance was because the organic bonding layer 16 having a lower refractive index was used.

### Comparative Example 1

A color conversion layer 14 was laminated on color filter layers 12 and a black matrix by repetition of the same procedure as in Example 1 except that no bonding layer (neither organic bonding layer 16 nor inorganic bonding layer 13) was formed. Adhesiveness of the color conversion layer 14 to the color filter layers 12 was however so poor that the color conversion layer 14 was separated partially.

### Comparative Example 2

An organic EL light emitting display was obtained by repetition of the same procedure as in Example 1 except that the color conversion layer 14 was formed by using a procedure due to wet process as follows. DCM-1 (0.7 part by weight) was dissolved in 120 part by weight of propylene glycol monoethyl acetate (PGMEA) as a solvent. 100 part by weight of “VPA100” (tradename, made by Nippon Steel Chemical Co., Ltd.) as a photopolymerizable resin composition was added thereto and dissolved to thereby obtain a coating composition. This coating composition was applied onto the inorganic bonding layer 13 by a spin coating method to thereby form a color conversion layer having a film thickness of 10 μmm.

When the obtained display was continuously driven at 85° C. for 1000 hours in the condition that white light (initial chromaticity (CIE), x=0.31, y=0.33) was emitted with a luminance of 1000 cd/m², several dark areas per 1 cm² were generated.

1. An organic EL light emitting display successively comprising a transparent substrate, one kind or a plurality of kinds of color filter layers, a bonding layer, a color conversion layer, a barrier layer, a transparent electrode, an organic EL layer, and a reflecting electrode, characterized in that:
the color filter layer is formed by wet process;
the color conversion layer and the barrier layer are formed by dry process; and
the bonding layer is selected from a group consisting of an inorganic bonding layer, an organic bonding layer, and a laminated body of an organic bonding layer and an inorganic bonding layer.

2. An organic EL light emitting display according to claim 1, characterized in that the refractive index of the barrier layer is larger than the refractive index of the color conversion layer and smaller than the refractive index of the transparent electrode.

3. An organic EL light emitting display according to claim 2, characterized in that the refractive index of the barrier layer is larger than 1.9 and smaller than 2.2.

4. An organic EL light emitting display according to claim 1, characterized in that the color conversion layer is formed by an evaporation method.

5. An organic EL light emitting display according to claim 1, characterized in that the color conversion layer is formed from one kind or a plurality of kinds of color conversion pigments.

6. An organic EL light emitting display according to claim 1, further comprising a black matrix, characterized in that the black matrix is arranged in gaps of the one kind or the plurality of kinds of color filter layers.

7. An organic EL light emitting display according to claim 1, characterized in that the organic bonding layer has a refractive index not larger than 1.5.

8. An organic EL light emitting display according to claim 1, characterized in that the organic bonding layer is formed of silicone resin.

9. An organic EL light emitting display according to claim 1, characterized by further comprising a buffer layer between the color conversion layer and the barrier layer.

10. An organic EL light emitting display according to claim 9, characterized in that the buffer layer contains a material tolerant for film-forming process.

11. An organic EL light emitting display according to claim 9, characterized in that the buffer layer is formed by a resistance heating evaporation method or an electron beam heating evaporation method.

12. An organic EL light emitting display according to claim 1, characterized in that the color conversion layer is formed selectively in a position corresponding to the one kind of color filter layer or at least one of the plurality of kinds of color filter layers.
